(19) United States
(12) Patent Application Publication
(10) Pub. No.: US 2024/0241963 A1
(43) Pub. Date: Jul. 18, 2024

(54) LEARNING BASED IDENTIFICATION OF VULNERABLE FUNCTIONS IN RELATION TO COMMON VULNERABILITIES AND EXPOSURES (CVE)

(71) Applicant: MICRO FOCUS LLC, Santa Clara, CA (US)

(72) Inventors: Emil Wareus, Malmo (SE); Magnus Tullberg, Kista (SE); Anton Duppils, Kista (SE)

(73) Assignee: MICRO FOCUS LLC, SANTA CLARA, CA (US)

(21) Appl. No.: 18/098,582

(22) Filed: Jan. 18, 2023

(51) Int. Cl. G06F 21/57

(52) U.S. Cl. CPC G06F 21/577; G06F 2221/033

(57) ABSTRACT

Embodiments of the disclosure provide systems and methods for accurately identifying functions in software code that represent vulnerabilities. Identifying vulnerable functions in software code can comprise collecting information identifying one or more known Common Vulnerabilities and Exposures (CVEs) and identifying one or more vulnerable functions in the software code based on relationships between the collected information identifying the one or more known CVEs and the one or more vulnerable functions in the software code. A call graph can be derived for the software code based on the identified one or more vulnerable functions. Each of the identified one or more vulnerable functions can be indicated in the call graph by a vulnerability symbol. A determination can be made as to whether each identified one or more vulnerable functions is a true vulnerability, i.e., when the vulnerable function is encountered when traversing the call graph.

### FIELD OF THE DISCLOSURE

Embodiments of the present disclosure relate generally to methods and systems for analyzing security of software and more particularly to identifying vulnerable functions in software code.

### BACKGROUND

Vulnerabilities in computer software are flaws that weaken the overall security of the devices and/or systems executing that software. Vulnerabilities can be exploited by a threat actor, such as an attacker, to cross privilege boundaries, i.e., perform unauthorized actions, within a computer system. The Common Vulnerabilities and Exposures (CVE) system provides a reference-method for publicly known information-security vulnerabilities and exposures. This information can be used to perform a susceptibility analysis on software in an attempt to identify and correct vulnerabilities therein. When managing vulnerabilities in software it is critical to reduce the false positive rate and increase the actionable intelligence for each vulnerability. Hence, there is a need for improved methods and systems for accurately identifying functions in software code that represent true vulnerabilities.

### BRIEF SUMMARY

Embodiments of the disclosure provide systems and methods for accurately identifying functions in software code that represent true vulnerabilities, i.e., a vulnerability that can actually arise during execution of the software code. According to one embodiment, a method for identifying vulnerable functions in software code can comprise collecting information identifying one or more known Common Vulnerabilities and Exposures (CVEs) and identifying one or more vulnerable functions in the software code based on relationships between the collected information identifying the one or more known CVEs and the one or more vulnerable functions in the software code. Identifying the one or more vulnerable functions in the software code can comprise identifying a patch commit for each identified one or more vulnerable functions. For example, identifying the patch commit for each identified one or more vulnerable function can comprise analyzing metadata for each identified one or more vulnerable function using a trained model. Identifying the one or more vulnerable functions in the software code can further comprise identifying a link to the identified patch commit for each identified one or more vulnerable function. Identifying the one or more vulnerable functions in the software code further comprises generating a vulnerability symbol for each of the one or more identified vulnerability functions. A call graph can be derived for the software code based on the identified one or more vulnerable functions. Each of the identified one or more vulnerable functions can be indicated in the call graph by a generated vulnerability symbol.

A determination can be made as to whether each identified one or more vulnerable functions is a true vulnerability by analyzing the call graph. For example, determining whether each identified one or more vulnerable functions is a true vulnerability can comprise traversing the call graph. The vulnerable function can be determined to be a true vulnerability when the vulnerable function is encountered when traversing the call graph. A plurality of patches for the software code can then be aggregated based on the identified one or more vulnerable functions determined to be true vulnerabilities.

According to another embodiment, a system can comprise a processor and a memory coupled with and readable by the processor. The memory can store therein a set of instructions which, when executed by the processor, causes the processor to identify vulnerable functions in software code by collecting information identifying one or more known Common Vulnerabilities and Exposures (CVEs) and identifying one or more vulnerable functions in the software code based on relationships between the collected information identifying the one or more known CVEs and the one or more vulnerable functions in the software code. Identifying the one or more vulnerable functions in the software code can comprise identifying a patch commit for each identified one or more vulnerable functions. For example, identifying the patch commit for each identified one or more vulnerable function can comprise analyzing metadata for each identified one or more vulnerable function using a trained model. Identifying the one or more vulnerable functions in the software code can further comprise identifying a link to the identified patch commit for each identified one or more vulnerable function. Identifying the one or more vulnerable functions in the software code further comprises generating a vulnerability symbol for each of the one or more identified vulnerability functions. The instructions can further cause the processor to derive a call graph for the software code based on the identified one or more vulnerable functions. Each of the identified one or more vulnerable functions can be indicated in the call graph by a generated vulnerability symbol.

The instructions can further cause the processor to make a determination as to whether each identified one or more vulnerable functions is a true vulnerability by analyzing the call graph. For example, determining whether each identified one or more vulnerable functions is a true vulnerability can comprise traversing the call graph. The vulnerable function can be determined to be a true vulnerability when the vulnerable function is encountered when traversing the call graph. The instructions can further cause the processor to aggregate a plurality of patches for the software code based on the identified one or more vulnerable functions determined to be true vulnerabilities.

According to yet another embodiment, a non-transitory, computer-readable medium can comprise a set of instructions stored therein which, when executed by a processor, causes the processor to identify vulnerabilities in software code by collecting information identifying one or more known Common Vulnerabilities and Exposures (CVEs) and identifying one or more vulnerable functions in the software code based on relationships between the collected information identifying the one or more known CVEs and the one or more vulnerable functions in the software code. Identifying the one or more vulnerable functions in the software code can comprise identifying a patch commit for each identified one or more vulnerable functions. For example, identifying the patch commit for each identified one or more vulnerable function can comprise analyzing metadata for each identified one or more vulnerable function using a trained model. Identifying the one or more vulnerable functions in the software code can further comprise identifying a link to the identified patch commit for each identified one or more vulnerable function. Identifying the one or more vulnerable functions in the software code further comprises generating a vulnerability symbol for each of the one or more identified vulnerability functions. The instructions can further cause the processor to derive a call graph for the software code based on the identified one or more vulnerable functions. Each of the identified one or more vulnerable functions can be indicated in the call graph by a generated vulnerability symbol.

The instructions can further cause the processor to make a determination as to whether each identified one or more vulnerable functions is a true vulnerability by analyzing the call graph. For example, determining whether each identified one or more vulnerable functions is a true vulnerability can comprise traversing the call graph. The vulnerable function can be determined to be a true vulnerability when the vulnerable function is encountered when traversing the call graph. The instructions can further cause the processor to aggregate a plurality of patches for the software code based on the identified one or more vulnerable functions determined to be true vulnerabilities.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating exemplary elements of an exemplary environment for performing susceptibility analysis according to one embodiment of the present disclosure.

FIG. 4 is a flowchart illustrating an exemplary process for performing susceptibility analysis according to one embodiment of the present disclosure.

FIG. 5 is a flowchart illustrating an exemplary process for identifying vulnerable functions in software code according to one embodiment of the present disclosure.

FIG. 6 is a flowchart illustrating an exemplary process for determining whether an identified vulnerability is a true vulnerability according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

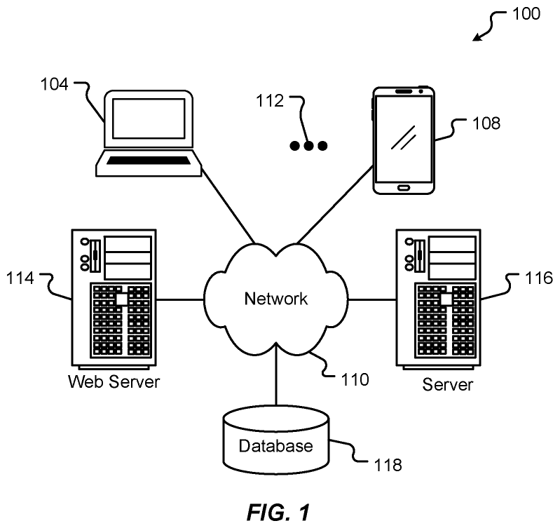

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

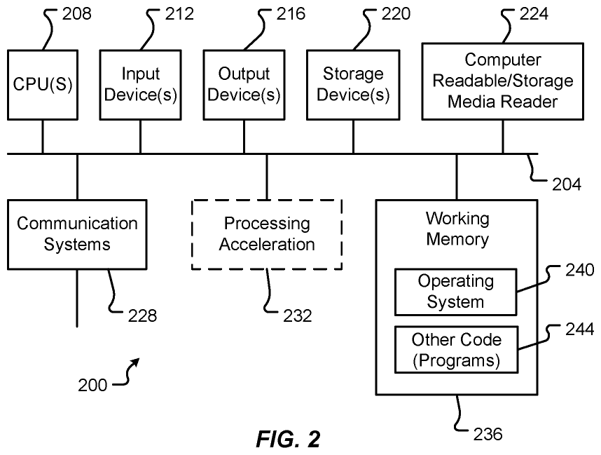

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Embodiments of the disclosure provide systems and methods for accurately identifying functions in software code that represent true vulnerabilities, i.e., a vulnerability that can actually arise during execution of the software code. According to one embodiment, identifying vulnerable functions in software code, such as open-source software code, can comprise collecting information identifying one or more known Common Vulnerabilities and Exposures (CVEs) and identifying one or more vulnerable functions in the software code based on relationships between the collected information identifying the one or more known CVEs and the one or more vulnerable functions in the software code. A call graph can be derived for the software code based on the identified one or more vulnerable functions. Each of the identified one or more vulnerable functions can be indicated in the call graph by a vulnerability symbol. A determination can be made as to whether each identified one or more vulnerable functions is a true vulnerability by analyzing the call graph. A function can be determined to be a true vulnerability when the vulnerable function, represented by a vulnerability symbol in the call graph, is encountered when traversing the call graph. A plurality of patches for the software code can then be aggregated based on the identified one or more vulnerable functions determined to be true vulnerabilities.

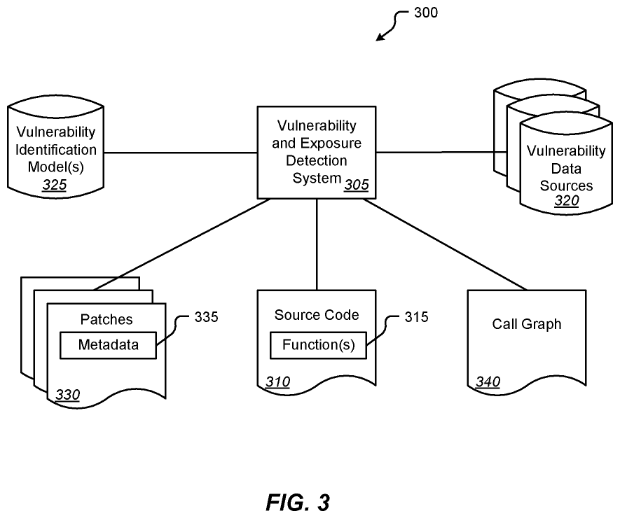

FIG. 3 is a block diagram illustrating exemplary elements of an exemplary environment for performing susceptibility analysis according to one embodiment of the present disclosure. As illustrated in this example, the environment 300 can comprise a vulnerability and exposure detection system 305. The vulnerability and exposure detection system 305 can comprise any one or more servers and/or other computing devices as described above. Generally speaking, and as will be described in greater detail below, the vulnerability and exposure detection system 305 can analyze software source code 310, such as an open-source application, to determine if any functions 315 within that source code 310 represent a vulnerability or exposure to a system executing that code. To do so, the vulnerability and exposure detection system 305 can collect vulnerabilities information by scraping one or more vulnerability data sources 320 such as advisories and/or databases as known in the art, such as the National Vulnerability Database (NVD).

The vulnerability and exposure detection system 305 can then relate known vulnerabilities to the software source code 310. This can be done, for example, using one or more trained models 325 which define, for example, relationships between information from the vulnerability data sources 320 to portions of software code. The output from this can be a relation between a vulnerability data and the source code 310 repository/package, version range, etc.

The vulnerability and exposure detection system 305 can also access a set of known patches 330 for the source code 310. Each patch 330 can include metadata 335 defining or identifying patch commits for the patch 330. For each vulnerability, repository/package, and version range pair the vulnerability and exposure detection system 305 can determine the patch commit that patches a particular vulnerability by analyzing references in the metadata, the vulnerability data, and a model 325 trained to identify security patches from that input data.

This analysis finds links to issues, pull requests, or commits in the target repository of the source code 310. For issues and pull requests, the vulnerability and exposure detection system 305 can in turn analyze what commits are linked to those entities to find the patch commit. In addition to this, the vulnerability and exposure detection system 305 can analyze all commits, pull requests, issues, and code-diffs related to that particular version range with the model 325 trained to identify security patches. From the positive predictions, the model trained to identify security patches can identify the most likely commit(s) to contain the security patch, and label those as the patch commit(s) for an identified vulnerability.

Using the identified patch commits, the vulnerability and exposure detection system 305 can, through analysis of the changed files in those particular commits, label the changed functions/methods/classes of the source code 310 as the vulnerable functionality with a vulnerability symbol. These symbols can comprise any graphical and/or textual indicator made to be uniquely identified, which can be a different process for each programming language, but can comprise constructing a call graph 340 such as an abstract syntax tree for those changed files, and appending the namespace to the corresponding functions/methods/classes that match a call graph representation of that particular language.

For some vulnerabilities, there may be multiple patches for different major versions of the software source code 310. This can mean that the fix can be present in multiple versions and look different between versions. To handle this, the vulnerability and exposure detection system 305 can append all variations of the vulnerable functionality and relates those to that particular CVE, along with the affected versions for each vulnerable functionality.

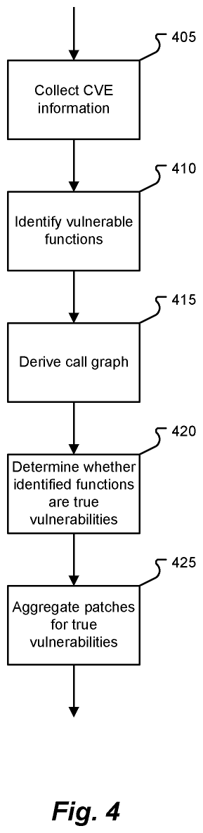

FIG. 4 is a flowchart illustrating an exemplary process for performing susceptibility analysis according to one embodiment of the present disclosure. As illustrated in this example, identifying vulnerable functions in software code can comprise collecting 405 information identifying one or more known CVEs from any of a number of possible sources as described above.

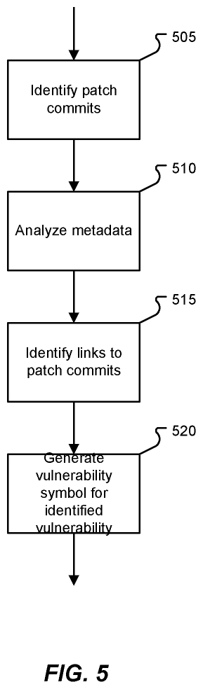

One or more vulnerable functions in the software code can then be identified 410 based on relationships between the collected information identifying the one or more known CVEs and the functions in the software code. Additional details of an exemplary process for identifying 410 vulnerable functions will be described below with reference to FIG. 5.

A call graph for the software code can be derived 415 based on the identified one or more vulnerable functions. Each of the identified one or more vulnerable functions can be indicated or marked in the call graph by a vulnerability symbol as described above.

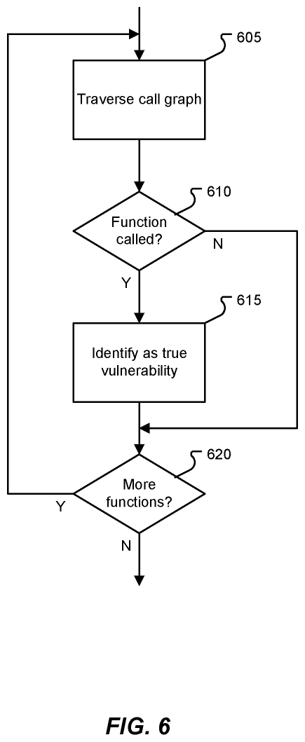

A determination 420 can then be made as to whether each identified vulnerable function is a true vulnerability by analyzing the call graph. Additional details of an exemplary process for determining whether a vulnerability is a true vulnerability will be described below with reference to FIG. 6.

A plurality of patches for the software code aggregating 425 based on the identified one or more vulnerable functions determined to be true vulnerabilities. That is, patches for variations and affected versions of the vulnerable functionality can be related to a particular CVE.

FIG. 5 is a flowchart illustrating an exemplary process for identifying vulnerable functions in software code according to one embodiment of the present disclosure. As illustrated in this example, identifying the one or more vulnerable functions in the software code can be based on a trained model and can comprise identifying 505 a patch commit for each identified one or more vulnerable functions. In some cases, identifying 505 the patch commit for each identified one or more vulnerable function can further comprise analyzing 510 metadata for each identified one or more vulnerable function using a trained model. Identifying the one or more vulnerable functions in the software code can also comprise identifying 515 a link to the identified patch commit for each identified one or more vulnerable function. For each identified vulnerability, a vulnerability symbol can be generated 520. For example, generating 520 a vulnerability symbol can comprise deriving an Abstract Syntax Tree (AST) for patch commits and turning the AST into a vulnerability symbol.

FIG. 6 is a flowchart illustrating an exemplary process for determining whether an identified vulnerability is a true vulnerability according to one embodiment of the present disclosure. As illustrated in this example, determining whether each identified vulnerable function is a true vulnerability can comprise traversing 605 and determining 610 whether the function is called. In response to determining 610 a function is called, i.e., is encountered when traversing the call graph, the vulnerable function can be determined or identified 615 to be a true vulnerability. A further determination 620 can be made as to whether any other identified vulnerabilities remain. In response to determining 620 additional vulnerable functions remain to be checked, the process of traversing 605 the call graph, determining 610 whether the function is encountered or called, and identifying 615 those vulnerable functions which are encountered as true vulnerabilities can be repeated until all identified vulnerable functions have been checked.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for identifying vulnerable functions in software code, the method comprising:
collecting, by a vulnerability and exposure detection system, information identifying one or more known Common Vulnerabilities and Exposures (CVEs);
identifying, by the vulnerability and exposure detection system, one or more vulnerable functions in the software code based on relationships between the collected information identifying the one or more known CVEs and the one or more vulnerable functions in the software code;
deriving, by the vulnerability and exposure detection system, a call graph for the software code based on the identified one or more vulnerable functions, wherein each of the identified one or more vulnerable functions are indicated in the call graph by a vulnerability symbol; and
determining, by the vulnerability and exposure detection system, whether each identified one or more vulnerable functions is a true vulnerability by analyzing the call graph.

2. The method of claim 1, wherein identifying the one or more vulnerable functions in the software code further comprises identifying a patch commit for each identified one or more vulnerable functions.

3. The method of claim 2, wherein identifying the patch commit for each identified one or more vulnerable function comprises analyzing metadata for each identified one or more vulnerable function using a trained model.

4. The method of claim 1, wherein identifying the one or more vulnerable functions in the software code further comprises identifying a link to the identified patch commit for each identified one or more vulnerable function.

5. The method of claim 1, identifying the one or more vulnerable functions in the software code further comprises generating a vulnerability symbol for each of the one or more identified vulnerability functions.

6. The method of claim 1, wherein determining whether each identified one or more vulnerable functions is a true vulnerability comprises traversing the call graph and wherein the vulnerable function determined to be a true vulnerability when the vulnerable function is encountered when traversing the call graph.

7. The method of claim 1, further comprising aggregating, by the vulnerability and exposure detection system, a plurality of patches for the software code based on the identified one or more vulnerable functions determined to be true vulnerabilities.

8. A system comprising:
a processor; and
a memory coupled with and readable by the processor and storing therein a set of instructions which, when executed by the processor, causes the processor to identify vulnerable functions in software code by:
collecting information identifying one or more known Common Vulnerabilities and Exposures (CVEs);
identifying one or more vulnerable functions in the software code based on relationships between the collected information identifying the one or more known CVEs and the one or more vulnerable functions in the software code;
deriving a call graph for the software code based on the identified one or more vulnerable functions, wherein each of the identified one or more vulnerable functions are indicated in the call graph by a vulnerability symbol; and
determining whether each identified one or more vulnerable functions is a true vulnerability by analyzing the call graph.

9. The system of claim 8, wherein identifying the one or more vulnerable functions in the software code further comprises identifying a patch commit for each identified one or more vulnerable functions.

10. The system of claim 9, wherein identifying the patch commit for each identified one or more vulnerable function comprises analyzing metadata for each identified one or more vulnerable function using a trained model.

11. The system of claim 8, wherein identifying the one or more vulnerable functions in the software code further comprises identifying a link to the identified patch commit for each identified one or more vulnerable function.

12. The system of claim 8, identifying the one or more vulnerable functions in the software code further comprises generating a vulnerability symbol for each of the one or more identified vulnerability functions.

13. The system of claim 8, wherein determining whether each identified one or more vulnerable functions is a true vulnerability comprises traversing the call graph and wherein the vulnerable function determined to be a true vulnerability when the vulnerable function is encountered when traversing the call graph.

14. The system of claim 8, further comprising aggregating, by the vulnerability and exposure detection system, a plurality of patches for the software code based on the identified one or more vulnerable functions determined to be true vulnerabilities.

15. A non-transitory, computer-readable medium comprising a set of instructions stored therein which, when executed by a processor, causes the processor to identify vulnerabilities in software code by:
collecting information identifying one or more known Common Vulnerabilities and Exposures (CVEs);
identifying one or more vulnerable functions in the software code based on relationships between the collected information identifying the one or more known CVEs and the one or more vulnerable functions in the software code;
deriving a call graph for the software code based on the identified one or more vulnerable functions, wherein each of the identified one or more vulnerable functions are indicated in the call graph by a vulnerability symbol; and
determining whether each identified one or more vulnerable functions is a true vulnerability by analyzing the call graph.

16. The non-transitory, computer-readable medium of claim 15, wherein identifying the one or more vulnerable functions in the software code further comprises:
identifying a patch commit for each identified one or more vulnerable functions; and
analyzing metadata for each identified one or more vulnerable function using a trained model.

17. The non-transitory, computer-readable medium of claim 15, wherein identifying the one or more vulnerable functions in the software code further comprises identifying a link to the identified patch commit for each identified one or more vulnerable function.

18. The non-transitory, computer-readable medium of claim 15, identifying the one or more vulnerable functions in the software code further comprises generating a vulnerability symbol for each of the one or more identified vulnerability functions.

19. The non-transitory, computer-readable medium of claim 15, wherein determining whether each identified one or more vulnerable functions is a true vulnerability comprises traversing the call graph and wherein the vulnerable function determined to be a true vulnerability when the vulnerable function is encountered when traversing the call graph.

20. The non-transitory, computer-readable medium of claim 15, further comprising aggregating, by the vulnerability and exposure detection system, a plurality of patches for the software code based on the identified one or more vulnerable functions determined to be true vulnerabilities.
